(19) United States
(12) Patent Application Publication
(10) Pub. No.: US 2009/0111695 A1
(43) Pub. Date: Apr. 30, 2009

(54) AROMATIC SOLVENT FREE HERBICIDAL FORMULATIONS OF FLUROXYPYR MEPTYL ESTER WITH C4-C8 ESTERS OF TRICLOPYR, 2,4-D OR MCPA

(75) Inventors: Jeffrey L. Jensen, Brownsburg, IN (US); Gary L. Sampson, Martinsville, IN (US); Franklin N. Keeney, Carmel, IN (US)

Correspondence Address: DOW AGROSCIENCES LLC, 9330 ZIONSVILLE RD, INDIANAPOLIS, IN, 46268, US

(73) Assignee: Dow AgroSciences LLC, Indianapolis, IN (US)

(21) Appl. No.: 12/257,444

(22) Filed: Oct. 24, 2008

Related U.S. Application Data
(60) Provisional application No. 61/000,250, filed on Oct. 24, 2007.

(51) Int. Cl. A01N 43/40

(52) U.S. Cl. 504/130

(57) ABSTRACT

This invention relates to formulations of fluoroxypyr meptyl ester with C₄-C₈ esters of triclopyr, 2,4-D or MCPA that are free of aromatic hydrocarbon solvents.

This application claims the benefit of U.S. Provisional Application Ser. No. 61/000,250 filed on Oct. 24, 2007. The present invention relates to herbicidal formulations of fluoroxypyr meptyl ester with C₄-C₈ esters of triclopyr, 2,4-D or MCPA. More particularly, the present invention concerns formulations of fluoroxypyr meptyl ester with C₄-C₈ esters of triclopyr, 2,4-D or MCPA that are free of aromatic hydrocarbon solvents.

### BACKGROUND OF THE INVENTION

In today's agrichemical market, it becomes increasingly common to design formulations to contain multiple active ingredients and their required solvents, safeners, and/or adjuvants, etc., in order to achieve the optimal spectrum, efficacy, and delivery efficiency, which consequently makes formulation stability more and more challenging.

Fluoroxypyr is a known, effective herbicide for the control of broad-leaved weeds. Fluoroxypyr meptyl ester, which is a solid, is typically formulated as an emulsifiable concentrate at a concentration of about 26 weight percent in aromatic hydrocarbon solvents (for example, Dow AgroSciences' Starane™ herbicide). Aromatic hydrocarbon solvents have historically been used to maintain stability at low temperature in fluoroxypyr meptyl formulations. Triclopyr is a known effective herbicide for the control of broad-leaved weeds and woody plants. Triclopyr's herbicidal activity is complimentary to that of fluoroxypyr. Triclopyr butoxyethyl ester is typically formulated as an emulsifiable concentrate at a concentration of about 61 weight percent in aromatic hydrocarbon solvents (for example, Dow AgroSciences' Garlon 4™ herbicide). (2,4-Dichlorophenoxy)-acetic acid (2,4-D) is a known effective herbicide for the control of broad-leaved weeds. 2,4-D's herbicidal activity is complimentary to that of fluoroxypyr. 2,4-D 2-ethylhexyl ester is typically formulated as an emulsifiable concentrate at a concentration of about 66 weight percent in kerosene and polyglycol solvents (for example, Nufarm's Esteron™ herbicide). (4-Chloro-2-methylphenoxy)acetic acid (MCPA) is a known effective herbicide for the control of broad-leaved weeds. MCPA's herbicidal activity is complimentary to that of fluoroxypyr. MCPA 2-ethylhexyl ester is typically formulated as an emulsifiable concentrate at a concentration of about 68 weight percent in petroleum distillate solvents (for example, Nufarm's Rhonox™ herbicide). While emulsifiable concentrate formulations can be prepared using chlorinated solvents or 1-methyl-2-pyrrolidinone, these solvents have less than preferred environmental profiles. In fact, some of the compounds used as solvents are being subjected to increasing regulatory scrutiny. Currently, some governing bodies are considering banning or limiting the use of some organic solvents. Removing objectionable solvents from the current herbicide formulations would significantly alter their physical properties including their storage stability and suitability for use. Consequently, it would be preferable to provide alternate formulations that have significantly reduced amounts of solvents or are essentially free of solvents.

### SUMMARY OF THE INVENTION

Surprisingly, it has now been found that low-temperature stable, emulsifiable concentrates and emulsion-in-water concentrates of fluoroxypyr meptyl ester with C₄-C₈ esters of triclopyr, 2,4-D or MCPA can be prepared without aromatic solvents if the weight ratio of fluoroxypyr meptyl ester to the C₄-C₈ ester of triclopyr, 2,4-D or MCPA is in the range from about 1:1 to about 1:4. This allows less efficient but more environmentally benign adjuvants like seed/vegetable oils and methylated seed/vegetable oils to be used to control concentrate viscosity and commercial active loading levels without sacrificing low temperature physical stability. The formulations of the present invention contain one or more surfactants selected to maintain the herbicidal esters as an emulsion upon dilution; and optionally, one or more adjuvants or compatible ingredients.

### DETAILED DESCRIPTION OF THE INVENTION

In general, the herbicidal formulation includes from about 30 weight percent to about 90 weight percent of the combined fluoroxypyr meptyl ester and the C₄-C₈ ester of triclopyr, 2,4-D or MCPA. The weight percentage of the C₄-C₈ ester of triclopyr, 2,4-D or MCPA is preferentially about two to three times that the fluoroxypyr meptyl ester.

The surfactants can be anionic, cationic or nonionic in character. Typical surfactants include salts of alkyl sulfates, such as diethanolammonium lauryl sulfate; alkylarylsulfonate salts, such as calcium dodecylbenzenesulfonate; alkyl and/or arylalkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalenesulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; and mixtures thereof. The surfactant or mixture of surfactants is usually present at a concentration of from about 2 to about 20 weight percent of the formulation.

In addition to the formulations set forth above, the present invention also embraces the compositions of these fluoroxypyr meptyl ester/C₄-C₈ ester of triclopyr, 2,4-D or MCPA formulations in combination with one or more additional compatible ingredients. Other additional ingredients may include, for example, one or more other herbicides, dyes, and any other additional ingredients providing functional utility, such as, for example, stabilizers, fragrants, viscosity-lowering additives, and freeze-point depressants.

Additional herbicidal compounds employed as supplements or additives should not be antagonistic to the activity of the fluoroxypyr meptyl ester/C₄-C₈ ester of triclopyr, 2,4-D or MCPA composition as employed in the present invention. Suitable herbicidal compounds include, but are not limited to ametryn, aminopyralid, asulam, atrazine, butafenacil, carfentrazone-ethyl, chlorflurenol, chlormequat, chlorpropham, chlorsulfuron, chlortoluron, cinosulfuron, clethodim, clopyralid, cyclosulfamuron, pyroxsulam, dicamba, dichlobenil, dichlorprop-P, diclosulam, diflufenican, diflufenzopyr, diuron, glyphosate, hexazinone, imazamox, imazapic, imazapyr, imazaquin, imazethapyr, imazosulfuron, metsulfuron-methyl, picloram, pyrithiobac-sodium, sethoxydim, sulfometuron, sulfosate, sulfosulfuron, tebuthiuron, terbacil, thiazopyr, thifensulfuron, triasulfuron and tribenuron. The herbicidal formulations of the present invention can be co-formulated with the other herbicide or herbicides, tank mixed with the other herbicide or herbicides, or applied sequentially with the other herbicide or herbicides.

Dyes may be used in the formulated composition as a marker. Generally, a preferred dye can be any oil-soluble dye selected from EPA's approved list of inerts exempt from tolerance. Such dyes may include, for example, D&C Red #17, D&C Violet #2, and D&C Green #6. Dyes are generally added to the composition by adding the desired amount of dye to the formulated composition with agitation. Dyes are generally present in the final formulation composition in a concentration of about 0.1-1.0% by weight.

The compositions of the present invention are diluted with water prior to being applied. The diluted compositions usually applied to cereals and range and pastures generally contain about 0.0001 to about 5.0 weight percent of the combined fluoroxypyr meptyl ester and C₄-C₈ ester of triclopyr, 2,4-D or MCPA.

### EXAMPLE 1

### Miscibility of Fluoroxypyr Meptyl Ester and Triclopyr Butoxyethyl Ester

The following test systems in Table I were prepared by blending molten fluoroxypyr meptyl ester (˜65° C.) into triclopyr butoxyethyl ester at ambient temperature until isotropic. Miscibility behavior is reported in Table I.

TABLE I

| Weight Ratio of Fluroxypyr | Miscibility Behavior | | |
|---|---|---|---|
| MHE to Triclopyr BEE | 20° C. | 5° C. | −5° C. |
| 4:1 | NM* | — | — |
| 3:2 | PM* | — | — |
| 2:3 | PM | — | — |
| 1:4 | M* | M | M |
| 1:3 | M | M | M |
| 1:2 | M | M | M |
| 1:1 | PM | — | — |

*NM = non miscible
PM = partially miscible, fluroxypyr MHE crystals ovservable
M = miscible, system is isotropic

The following test systems in Table II were prepared by blending molten fluoroxypyr meptyl ester (˜65° C.) into 2,4-D 2-ethylhexyl ester at ambient temperature until isotropic. Miscibility behavior is reported in Table II.

TABLE II

| Weight Ratio of Fluroxypyr | Miscibility Behavior | | |
|---|---|---|---|
| MHE to 2,4-D 2EH | 20° C. | 5° C. | −5° C. |
| 4:1 | NM | NM | NM |
| 3:2 | NM | NM | NM |
| 2:3 | M | M | NM |
| 1:4 | M | M | M |
| 1:3 | M | M | M |
| 1:2 | M | M | M |
| 1:1 | NM | NM | NM |

NM = non miscible
PM = partially miscible, fluroxypyr MHE crystals observable
M = miscible, system is isotropic

The following test systems in Table III were prepared by blending molten fluoroxypyr meptyl ester (˜65° C.) into MCPA 2-ethylhexyl ester at ambient temperature until isotropic. Miscibility behavior is reported in Table III.

TABLE III

| Weight Ratio of Fluroxypyr | Miscibility Behavior | | |
|---|---|---|---|
| MHE to MCPA 2EH | 20° C. | 5° C. | −5° C. |
| 4:1 | NM | NM | NM |
| 3:2 | M | M | M |
| 2:3 | M | M | M |
| 1:4 | M | M | M |
| 1:3 | M | M | M |
| 1:2 | M | M | M |
| 1:1 | M | M | M |

NM = non miscible
PM = partially miscible, fluroxypyr MHE crystals observable
M = miscible, system is isotropic

### EXAMPLE 2

### Emulsifiable Concentrate (EC)

Formulations A and B were prepared as follows. Molten fluoroxypyr meptyl ester (˜65° C.) was stirred at ambient temperature into triclopyr butoxyethyl ester and the remaining ingredients until an isotropic system was obtained.

Wt %

Formulation A

| | |
|---|---|
| Fluroxypyr MHE | 22.7 |
| Triclopyr BEE | 65.7 |
| Agnique BL 2904 (surfactant blend) | 11.6 |

Formulation B

| | |
|---|---|
| Fluroxypyr MHE | 15.3 |
| Triclopyr BEE | 44.4 |
| Agnique BL 2904 (surfactant blend) | 8.0 |
| Soybean Oil (viscosity modifier) | 32.3 |

### EXAMPLE 3

### Emulsion in Water Concentrate (EW)

Formulation C was prepared as follows. Molten fluoroxypyr meptyl ester (˜65° C.) was stirred at ambient temperature into a preblend oil phase consisting of triclopyr butoxyethyl ester, Amisoft HS-21P, Nikkol DGMS, Tween 61 and soybean oil until isotropic. This combined oil phase was vigorously mixed with a premix aqueous phase consisting of water, Proxel GXL, monosodium and disodium phosphate and propylene glycol until the total system was homogeneous.

Formulation C
Emulsion in Water Concentrate (EW)

| | Wt % |
|---|---|
| Fluroxypyr MHE | 7.9 |
| Triclopyr BEE | 22.9 |
| Amisoft HS-21P (surfactant) | 0.5 |
| Nikkol DGMS (surfactant) | 2.0 |
| Tween 61 (surfactant) | 1.4 |
| Soybean Oil (viscocity modifier) | 10.0 |
| Proxel GXL (biocide) | 0.3 |
| NaH₂PO₄•H₂O (buffer) | 0.2 |
| Na₂HPO₄ (buffer) | 0.3 |
| Proplyene Glycol (antifreeze) | 4.0 |
| Water | 50.5 |

What is claimed is:

1. An aromatic hydrocarbon-free herbicidal formulation comprising a mixture of fluoroxypyr meptyl ester with C₄-C₈ esters of triclopyr, 2,4-D or MCPA, wherein the weight ratio of the fluoroxypyr meptyl ester to the C₄-C₈ ester of triclopyr, 2,4-D or MCPA is in the range from about 1:1 to about 1:4.

2. A formulation of claim 1 comprising a mixture of fluoroxypyr meptyl ester and triclopyr butoxyethyl ester wherein the weight ratio of fluoroxypyr meptyl ester to triclopyr butoxyethyl ester is from about 1:2 to about 1:4.

3. A formulation of claim 1 comprising a mixture of fluoroxypyr meptyl ester and 2,4-D 2-ethylhexyl ester wherein the weight ratio of fluoroxypyr meptyl ester to 2,4-D 2-ethylhexyl ester is from about 1:1.5 to about 1:4.

4. A formulation of claim 1 comprising a mixture of fluoroxypyr meptyl ester and MCPA 2-ethylhexyl ester wherein the weight ratio of fluoroxypyr meptyl ester to MCPA 2-ethylhexyl ester is from about 1:1 to about 1:4.

5. A formulation of claim 1 comprising from about 30 weight percent to about 90 weight percent of the combined fluoroxypyr meptyl ester and C₄-C₈ ester of triclopyr, 2,4-D or MCPA and from about 2 to about 20 weight percent of a surfactant or mixture of surfactants.

6. A formulation of claim 1 which is an emulsifiable concentrate.

7. A formulation of claim 1 which is an emulsion in water concentrate.
